(19) United States
(12) Patent Application Publication
(10) Pub. No.: US 2012/0237705 A1
(43) Pub. Date: Sep. 20, 2012

(54) METHOD FOR COATING CONTAINERS

(75) Inventors: Ken W. Niederst, Allison Park, PA (US); Gregory J. McCollum, Gibsonia, PA (US); Michael A. Zalich, Pittsburgh, PA (US); Venkateshwarlu Kalsani, Allison Park, PA (US)

(73) Assignee: PPG Industries Ohio, Inc., Cleveland, OH (US)

(21) Appl. No.: 13/048,062

(22) Filed: Mar. 15, 2011

(51) Int. Cl. B32B 1/00; B05D 3/02

(52) U.S. Cl. 428/35.7; 428/34.1; 427/385.5

(57) ABSTRACT

A method for coating containers and the coated container is disclosed. The method uses a coating composition containing one or more ingredients containing beta-hydroxyester groups and a transesterification catalyst.

### FIELD OF THE INVENTION

The present invention relates to a method for coating containers of various sorts, such as food and beverage containers, with a composition that is curable via transesterification.

### BACKGROUND OF THE INVENTION

A wide variety of coatings have been used to coat the surfaces of food and beverage containers. For example, metal cans are sometimes coated using coil coating or sheet coating operations, that is, a plane or coil or sheet of a suitable substrate, for example, steel or aluminum, is coated with a suitable composition and cured. The coated substrate is then formed into the can body or can end. Alternatively, the coating composition may be applied, for example, by spraying, by flow coating and by dipping, to the formed can and then cured. Coatings for food and beverage containers should preferably be capable of high speed application to the substrate and provide the necessary properties when cured to perform in a demanding end use. For example, the coating should be safe for food contact and have excellent adhesion to the substrate.

Many of the coating compositions for food and beverage containers are based on epoxy resins that are the polyglycidyl ethers of bisphenol A and curing agents based on formaldehyde condensate or polyisocyanates. Bisphenol A is problematic in packaging coatings either as bisphenol A itself (BPA) or derivatives thereof, such as diglycidyl ethers of bisphenol A (BADGE). Although the balance of scientific evidence available to date indicates that small trace amounts of BPA or BADGE that might be released from existing coatings does not pose health risks to humans. These compounds are nevertheless perceived by some as being harmful to human health. Formaldehyde condensates such as aminoplasts and phenolplasts can also be problematic, because they can contain free formaldehyde or can release formaldehyde during the curing process. Chronic formaldehyde exposure can cause serious respiratory problems. Polyisocyanate curing agents must be handled with great care, since they can cause respiratory and sensitization problems. Consequently, there is a strong desire to eliminate these compounds from coatings for food and beverage containers. Accordingly, what is desired is a packaging coating composition for food or beverage containers that does not contain extractable quantities of BPA and/or BADGE, is curable without the need for formaldehyde condensate or polyisocyanates and yet has excellent cured film properties.

### SUMMARY OF THE INVENTION

The present invention provides a method of coating a container comprising:
(a) applying to the surface of the container a thermosetting composition comprising:
   (i) one or more ingredients containing beta-hydroxyester groups; the composition being essentially free of curing agents containing functional groups that are reactive with hydroxyl groups, and
   (ii) a transesterification catalyst;
(b) heating the composition applied in step (a) to a temperature sufficient to cure the composition.

The present invention also provides for a coated container comprising a container body and a cured, thermoset coating derived from a composition comprising:
(a) one or more ingredients containing beta-hydroxyester groups; the composition being essentially free of curing agents that have groups that are co-reactive with hydroxyl groups, and
(b) a transesterification catalyst.

### DETAILED DESCRIPTION

As used herein, unless otherwise expressly specified, all numbers such as those expressing values, ranges, amounts or percentages may be read as if prefaced by the word “about”, even if the term does not expressly appear. Moreover, it should be noted that plural terms and/or phrases encompass their singular equivalents and vice versa. For example, “a” polymer, “a” crosslinker, and any other component refers to one or more of these components.

When referring to any numerical range of values, such ranges are understood to include each and every number and/or fraction between the stated range minimum and maximum.

As employed herein, the term “polyol” or variations thereof refers broadly to a material having an average of two or more hydroxyl groups per molecule. The term “polycarboxylic acid” refers to the acids and functional derivatives thereof, including anhydride derivatives where they exist, and lower alkyl esters having 1-4 carbon atoms.

As used herein, the term “polymer” refers broadly to prepolymers, oligomers and both homopolymers and copolymers. The terms “resin” and “polymer” and “resinous” and “polymeric” are used interchangeably.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, ethacrylic acid, etc., and their C₁-C₅ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “acrylic polymer” refers to polymers prepared from one or more (meth)acrylic monomers. “Lower alkyl” acrylates refers to alkyl groups of 1 to 4 carbon atoms.

The term “container” refers to container bodies and container ends. The surface of the container refers to the interior or exterior surface of the container.

As used herein, “a” and “the at least one” and “one or more” are used interchangeably. Thus, for example, a coating composition that comprises “a” polymer can be interpreted to mean the coating composition includes “one or more” polymers.

As used herein, molecular weights are determined by gel permeation chromatography using a polystyrene standard. Unless otherwise indicated, the molecular weight is number average molecular weight (Mₙ).

The composition that is used in the method of the invention and which is used in forming the coated container is typically an acrylic polymer containing beta-hydroxyester groups. The acrylic polymer may be the sole resinous ingredient in the thermosetting composition or may be in admixture with a second polymer different from the acrylic polymer and containing hydroxyl groups. The acrylic polymer containing the beta-hydroxyester groups and/or the second polymer may also contain lower alkyl ester groups.

The acrylic polymer is prepared by copolymerizing (meth)acrylic monomers containing beta-hydroxyester groups with other copolymerizable ethylenically unsaturated monomers. Examples of (meth)acrylic monomers containing beta-hydroxyester groups are hydroxyethyl (meth)acrylate and hydroxypropyl (meth)acrylate. Examples of copolymerizable ethylenically unsaturated monomers are lower alkyl acrylates such as methyl (meth)acrylate, ethyl (meth)acrylate and butyl (meth)acrylate and dimethyl itaconate. Examples of other copolymerizable ethylenically unsaturated monomers include vinyl monomers and allylic monomers. Vinyl esters include vinyl acetate, vinyl propionate, vinyl butyrates, vinyl benzoates, vinyl isopropyl acetates, and similar vinyl esters. Vinyl halides include vinyl chloride, vinyl fluoride, and vinylidene chloride. Vinyl aromatic hydrocarbons include styrene, methyl styrenes, and similar lower alkyl styrenes, chlorostyrene, vinyl toluene, vinyl naphthalene, divinyl benzoate, and cyclohexene. Vinyl aliphatic hydrocarbon monomers include alpha olefins such as ethylene, propylene, isobutylene, and cyclohexyl as well as conjugated dienes such as butadiene, methyl-2-butadiene, 1,3-piperylene, 2,3-dimethyl butadiene, isoprene, cyclopentadiene, and dicyclopentadiene. Vinyl alkyl ethers include methyl vinyl ether, isopropyl vinyl ether, n-butyl vinyl ether, and isobutyl vinyl ether. Examples of allylic monomers include allyl alcohol and allyl chloride.

The acrylic polymer typically is prepared by conventional solution polymerization techniques using free radical initiators such as azo or peroxide catalyst. The polymers typically have molecular weights of from 1600 to 3000 g·mol⁻¹.

Typically the acrylic polymer contains from 10 to 90 percent by weight of units derived from beta-hydroxy alkyl (meth)acrylate with the remainder 10 to 90 percent being derived from other copolymerizable ethylenically unsaturated monomers. Usually the acrylic polymer contains from 10 to 70 percent by weight of the beta-hydroxy alkyl (meth)acrylate; 25 to 85 percent by weight of lower alkyl (meth)acrylates and 5 to 65 percent by weight of other copolymerizable ethylenically unsaturated monomers. The percentage by weight is based on total weight of the monomers used in preparing the acrylic polymer.

The acrylic polymers containing beta-hydroxy alkyl (meth)acrylate groups and preferably also with lower alkyl (meth)acrylate groups are self-curing and can be the sole curable polymeric component in the composition.

Alternatively, the acrylic polymer can be used in combination with other co-reactive materials such as hydroxy-functional materials and ester-containing polymers. Examples of hydroxy-functional materials are hydroxy-functional polymers different from the acrylic polymer described above. Examples of other hydroxy-functional materials are polymeric polyols such as hydroxy-functional alkyd resins, polyester polyols, polyurethane polyols and acrylic polyols. Such materials are described in U.S. Pat. No. 4,546,045, col. 2, line 37 to col. 4, line 46; the portions of which are hereby incorporated by reference. Typically, the hydroxy functional polymers contain from 0.0015 to 0.0050 moles of hydroxyl per gram of resin, although higher hydroxy contents may be used. Examples of ester-containing polymers are acrylic polymers prepared with lower alkyl acrylates. Typically, these acrylic polymers have lower alkyl ester contents of 0.0015 to 0.0050 moles per gram.

When mixtures of acrylic polymers containing beta-hydroxy alkyl groups and other polymeric polyols and ester-containing polymers are used, the (a) acrylic polymer containing the beta-hydroxy alkyl ester group is present in amounts of 10 to 90 percent by weight and (b) the other polymeric polyol or the ester-containing polymer is present in amounts of 10 to 90 percent by weight; the percentages by weight being based on total weight of (a) and (b).

The compositions also contain a transesterification catalyst. Examples include salts and complexes of titanium such as titanium acetyl acetonate and titanium tetraisopropoxide and tetra-n-butyl titanate. In addition, phosphotungstic acid can be used as a transesterification catalyst. Mixtures of catalysts may be used. Typically the catalyst is present in amounts of 0.5 to 5 percent by weight based on weight of resin solids in the coating composition.

Optional ingredients in the coating composition are diluents, such as water, or an organic solvent or a mixture of water and organic solvent to dissolve or disperse the resinous ingredients. The organic solvent is selected to have sufficient volatility to evaporate essentially entirely from the coating composition during the curing process such as during heating from 175-230° C. for about 5 to 30 minutes. Examples of suitable organic solvents are aliphatic hydrocarbons such as mineral spirits and high flash point VM&P naphtha; aromatic hydrocarbons such as benzene, toluene, xylene and solvent naphtha 100, 150, 200 and the like; ketones such as acetone, cyclohexanone, methylisobutyl ketone and the like; glycol ethers such as methoxypropanol and ethylene glycol dimethyl ether and ethylene glycol dibutyl ether and the like. Mixtures of various organic solvents can also be used. The diluent typically is used in the coating compositions in amounts of about 20 to 80, such as 30 to 70 percent by weight based on total weight of the coating composition.

Another useful optional ingredient is a lubricant, for example, a wax which facilitates manufacture of metal closures by imparting lubricity to the sheets of the coated metal substrate. Preferred lubricants include, for example, carnauba wax and polyethylene-type lubricants. If used, the lubricant is preferably present in the coating compositions at a minimum of 0.1 percent by weight based on weight of resin solids in the coating composition.

Another useful optional ingredient is a pigment such as titanium dioxide. If used, the pigment is present in the coating compositions in amounts no greater than 70 percent by weight, preferably no greater than 40 percent by weight based on total weight of solids in the coating composition.

Surfactants can optionally be added to the coating composition to aid in flow and wetting of the substrate. Examples of suitable surfactants include, but are not limited to, polyethers of nonyl phenol and salts. If used, the surfactant is present in amounts of at least 0.01 percent and no greater than 10 percent based on weight of resin solids in the coating composition.

The compositions used in the invention do not depend on curing agents that have groups that are co-reactive with hydroxyl groups. Such groups are defined as aminoplasts that are condensates of triazines with aldehydes such as formaldehyde; phenolplasts that are condensates of phenols with aldehydes such as formaldehyde, polyisocyanate including blocked polyisocyanate curing agents. The compositions are substantially free of such curing agents, preferably essentially free, and may even be completely free.

Besides being substantially free of the above-mentioned curing agents, the coating compositions can be formulated to be substantially free of bisphenol A (BPA) and bisphenol F (BPF) and derivatives thereof, such as aromatic glycidyl ether compounds of these materials such as the diglycidyl ether of bisphenol A (BADGE) and the diglycidyl ether of bisphenol F (BFDGE) and epoxy novolak resins prepared with bisphenol A and bisphenol F and condensates of bisphenol A and ethylene and/or propylene oxides. More preferably, the coating compositions are essentially completely free of these compounds, and most preferably, completely free of these compounds.

The term “substantially free” means the compositions of the present invention contain less than 1000 parts per million (ppm) of the recited compound. The term “essentially free” of a particular compound means the compositions contain less than 5 ppm of the recited compound. The term “completely free” of a particular compound means that the compositions contain less than 20 parts per billion (ppb) of the recited compound.

The coating compositions can be applied to containers of all sorts and are particularly well adapted for use on food and beverage cans (e.g., two-piece cans, three-piece cans, etc.). Besides food and beverage containers, the coating compositions can be applied to containers for aerosol applications such as deodorant and hair spray. After application as described below, the applied compositions are heated to a temperature sufficient to cure the coating. Typical curing temperatures are 175 to 230° C. for 5 to 30 minutes.

Two-piece cans are manufactured by joining a can body (typically a drawn metal body) with a can end (typically a drawn metal end). The coatings of the present invention are suitable for use in food or beverage contact situations and may be used on the inside or outside of such cans. They are particularly suitable for spray applied, liquid coatings, wash coatings, sheet coatings, over varnish coatings and side seam coatings.

Spray coating includes the introduction of the coating composition into the inside or outside of a preformed packaging container. Typical preformed packaging containers suitable for spray coating include food cans, beer and beverage containers, and the like. The sprayed preformed container is then subjected to heat to remove the residual solvents and harden the coating.

A coil coating is described as the coating, typically by a roll coating application, of a continuous coil composed of a metal (e.g., steel or aluminum). Once coated, the coated coil is subjected to a short thermal, ultraviolet, and/or electromagnetic curing cycle, for hardening (e.g., drying and curing) of the coating. Coil coatings provide coated metal (e.g., steel and/or aluminum) substrates that can be fabricated into formed articles, such as two-piece drawn food cans, three-piece food cans, food can ends, drawn and ironed cans, beverage can ends, and the like.

A wash coating is commercially described as the coating of the exterior of two-piece drawn and ironed (“D&I”) cans with a thin layer of protectant coating. The exterior of these D&I cans are “wash-coated” by passing preformed two-piece D&I cans under a curtain of a coating composition. The cans are inverted, that is, the open end of the can is in the “down” position when passing through the curtain. This curtain of coating composition takes on a “waterfall-like” appearance. Once these cans pass under this curtain of coating composition, the liquid coating material effectively coats the exterior of each can. Excess coating is removed through the use of an “air knife”. Once the desired amount of coating is applied to the exterior of each can, each can is passed through a thermal, ultraviolet, and/or electromagnetic curing oven to harden (e.g., dry and cure) the coating. The residence time of the coated can within the confines of the curing oven is typically from 1 minute to 60 minutes. The curing temperature within this oven will typically range from 160 to 200° C. The dry film thickness of the resultant coating is typically about 0.5 to 5 mils (12.7-127 microns) such as 1.0 to 2.5 mils (25.4-63.5 microns).

A sheet coating is described as the coating of separate pieces of a variety of materials (e.g., steel or aluminum) that have been pre-cut into square or rectangular “sheets”. Typical dimensions of these sheets are approximately one square meter. Once coated, each sheet is cured. Once hardened (e.g., dried and cured), the sheets of the coated substrate are collected and prepared for subsequent fabrication. Sheet coatings provide coated metal (e.g., steel or aluminum) substrate that can be successfully fabricated into formed articles, such as two-piece drawn food cans, three-piece food cans, food can ends, drawn and ironed cans, beverage can ends, and the like.

A side seam coating is described as the spray application of a liquid coating over the welded area of formed three-piece food cans. When three-piece food cans are being prepared, a rectangular piece of coated substrate is formed into a cylinder. The formation of the cylinder is rendered permanent due to the welding of each side of the rectangle via thermal welding. Once welded, each can typically requires a layer of liquid coating, which protects the exposed “weld” from subsequent corrosion or other effects to the contained foodstuff. The liquid coatings that function in this role are termed “side seam stripes”. Typical side seam stripes are spray applied and cured quickly via residual heat from the welding operation in addition to a small thermal, ultraviolet, and/or electromagnetic oven.

### EXAMPLES

The following examples are offered to aid in understanding of the present invention and are not to be construed as limiting the scope thereof. Unless otherwise indicated, all parts and percentages are by weight.

### Examples 1-4

In these examples, four coatings were prepared using an acrylic copolymer with ester and hydroxyl functionality, which was reduced to 40% solids using a mixture of Aromatic 100 and methyl amyl ketone (weight ratio of 50:50): 1) a control coating without catalyst, 2) a coating catalyzed with 2% by weight (of titania based on weight of resin solids) of titanium isopropoxide, 3) a coating catalyzed with 2% by weight (of titania based on weight of resin solids) of titanium n-butoxide and 4) a coating catalyzed with 2.5% by weight (based on weight of resin solids) of phosphotungstic acid(PTA). Coatings were drawn down using a #6 wire wound bar and baked for 12 minutes at 400° F. (204° C.). The coatings were evaluated for cure by rubbing with a methyl ethyl ketone saturated cloth. The results are reported in the Table below.

| Example | Acrylic resin¹ | Catalyst | MEK double rubs |
|---|---|---|---|
| 1 | HEA/HEMA/STY/EA | None | 5 |
| 2 | HEA/HEMA/STY/EA | Ti (IpOH) | 6 |
| 3 | HEA/HEMA/STY/EA | Ti (nBuO) | 100 |
| 4 | HEA/HEMA/STY/EA | PTA | 100 |

¹The acrylic resin containing ester and hydroxyl functionality was prepared using conventional solution polymerization techniques using Luperox 575 as a catalyst. The resin had a hydroxylethyl acrylate(HEA)/hydroxylethyl methacrylate (HEMA)/styrene(STY)/ethyl acrylate(EA) weight ratio of 15/17/42/26. The resin had a solids content of 59.3% in a mixture of Aromatic 100 and methyl amyl ketone (weight ratio of 50:50), a number average molecular weight (Mₙ) of about 5923 g · mol⁻¹ and a weight average molecular weight (M_{w}) of about 20061 g · mol⁻¹.

### Examples 5-12

In these Examples, an ester-containing resin of styrene/butyl acrylate/dimethyl itaconate (34/16/50 weight ratio) was blended with a hydroxyl functional resin of hydroxy butyl acrylate/styrene/2-ethylhexyl acrylate/methyl methacrylate/butyl methacrylate (22/22/10/26/20 weight ratio). The blend was formulated into three coating compositions by adding 0.5% by weight (of titania based on weight of resin solids) of titanium isopropoxide catalyst, 0.5% by weight (of titania based on weight of resin solids) of titanium n-butoxide catalyst and 1% by weight of phosphotungstic acid catalyst, respectively. Coatings were drawn down using a 2-mil drawdown bar and baked for 12 or 30 minutes at 400° F. (204° C.). The coatings were evaluated for cure by rubbing with a methyl ethyl ketone saturated cloth. The results are reported in Table I below.

TABLE I
Coating Formulations Using an Ester Functional Resin and a Hydroxyl Functional Resin

| Example | | Mole | | | | Cure | Cure Time in | MEK Double |
|---|---|---|---|---|---|---|---|---|
| No. | Ester Resin | Ester/g | OH Resin | Mole OH/g | Catalyst | Temperature | minutes | Rubs³ |
| 5 | STY/BA/DMI¹ | 0.0032 | HBA/STY/2-EHA/ | 0.0015 | Ti (IpOH) | 400° F. (204° C.) | 12 | 6 |
| | | | MMA/BMA² | | | | | |
| 6 | ″ | ″ | HBA/STY/2-EHA/ | ″ | Ti (nBuO) | ″ | ″ | >100 |
| | | | MMA/BMA² | | | | | |
| 7 | ″ | ″ | HBA/STY/2-EHA/ | ″ | PTA | ″ | ″ | 6 |
| | | | MMA/BMA² | | | | | |
| 8 | ″ | ″ | HBA/STY/2-EHA/ | ″ | None | ″ | ″ | 4 |
| | | | MMA/BMA² | | | | | |
| 9 | STY/BA/DMI | 0.0022 | HBA/STY/2-EHA/ | ″ | Ti (IpOH) | 400° F. (204° C.) | 30 | 40 |
| | | | MMA/BMA² | | | | | |
| 10 | ″ | ″ | HBA/STY/2-EHA/ | ″ | Ti (nBuO) | ″ | ″ | 60 |
| | | | MMA/BMA² | | | | | |
| 11 | ″ | ″ | HBA/STY/2-EHA/ | ″ | PTA | ″ | ″ | 6 |
| | | | MMA/BMA² | | | | | |
| 12 | ″ | ″ | HBA/STY/2-EHA/ | ″ | None | ″ | ″ | 3 |
| | | | MMA/BMA² | | | | | |

¹The ester-containing resin was prepared by conventional solvent-based solution polymerization techniques using t-butyl peroctoate catalyst. The resin had a styrene/butyl acrylate/dimethyl itaconate weight ratio of 34/16/50. The resin had a solids content of 56% in a mixture of dipropylene glycol dimethyl ether and methyl ethyl ketone (weight ratio of 63.5/36.5); a number average molecular weight (Mₙ) of about 4600 g · mol⁻¹ and a weight average molecular weight (M_{w}) of about 13,800 g · mol⁻¹.
²The hydroxyl-containing resin was prepared by conventional solvent-based solution polymerization techniques using di t-butyl peroxide catalyst. The resin had a hydroxy butyl acrylate/styrene/2-ethyl hexyl acrylate/methyl methacrylate/butyl methacrylate weight ratio of 22/22/10/26/20. The resin had a solids content of 64.97% in AROMATIC 100; a number average molecular weight (Mₙ) of 2918 g · mol⁻¹ and a weight average molecular weight (M_{w}) of 9979 g · mol⁻¹.
³Rubbing back and forth with a cotton cloth saturated with methyl ethyl ketone (MEK).
STY = Styrene,
BA = Butyl acrylate,
DMI = Dimethyl itaconate,
HBA = Hydroxy butyl acrylate,
2-EHA = 2-Ethyl hexyl acrylate,
MMA = Methyl methacrylate,
BMA = Butyl methacrylate,
Ti (IpOH) = Titanium (tetra-isopropoxide),
Ti (nBuO) = Titanium (tetra-n-butoxide), and
PTA = Phosphotungstic acid.

### Examples 13-16

A second series of experiments was conducted using an ester/hydroxyl functional resin. The ester/hydroxyl functional resin comprised hydroxypropyl acrylate/styrene/methyl methacrylate/butyl methacrylate/butyl acrylate/acrylic acid in a 40/20/0.5/18.5/19.0/2.0 weight ratio. The resin was prepared by conventional solution polymerization techniques using di t-amyl peroxide catalyst and AROMATIC 100/propylene glycol monomethyl ether acetate (40/60 weight ratio) solvent. The resin had a solids content of about 67% and an M_{w} of 8560 g·mol⁻¹. Three coating compositions were formulated by adding 0.5% by weight (of titania based on weight of resin solids) of titanium (tetra-isopropoxide) catalyst, 0.5% by weight (of titania based on weight of resin solids) of titanium (tetra-n-butoxide) catalyst and 1% (by weight based on weight of resin solids) phosphotungstic acid catalyst. The compositions were drawn down using a 2-mil drawdown bar and baked for 12 or 30 minutes at 300 and 400° F. (149 and 204° C.). A control coating without catalyst was prepared by baking for 12 minutes at 400° F. The coatings were evaluated for cure by rubbing with an MEK-saturated cloth. The results are reported in Table II below.

TABLE II
Coating Formulations Using an Ester/Hydroxyl Functional Resin,
Where X Denotes which Catalyst was Employed

| | | | | MEK Double | MEK Double | MEK Double | MEK Double |
|---|---|---|---|---|---|---|---|
| | | | | Rubs 12 | Rubs 12 | Rubs 30 | Rubs 30 |
| | | | | minutes @ | minutes @ | minutes @ | minutes @ |
| Example | Ti | Ti | | 300° F. | 400° F. | 300° F. | 400° F. |
| No. | (IpOH) | (nBuO) | PTA | (149° C.) | (204° C.) | (149° C.) | (204° C.) |
| 13 | X | | | 5 | 100 | 5 | 100 |
| 14 | | X | | 4 | 57 | 7 | 100 |
| 15 | | | X | 33 | 100 | 100 | 100 |
| 16 | | | | | 6 | | |

### Examples 17-22

The following Examples show curing of various ester/hydroxyl functional acrylic polymers. The polymers were prepared by conventional solution polymerization techniques in an aromatic solvent and using either di t-butyl or di t-amyl peroxide catalyst. The polymers had a solids content of about 66-70%, Mₙ values of 1600-3000 g·mol⁻¹ and M_{w} values of 4000-10,000 g·mol⁻¹. Four coating compositions were each formulated with 3% by weight based on resin solids of phosphotungstic acid. The coatings were drawn down on primed steel substrates with a 5-mil bird bar, flashed for 10 minutes and then cured at 140° C. for 30 minutes. After 24 hours, the films were tested for cure using MEK double rubs. The results are reported in Table III below.

TABLE III
Coating Formulations Using an Ester/Hydroxyl Functional Acrylic Polymer

| | | | | | | | | | | | | Function- | | Solvent |
|---|---|---|---|---|---|---|---|---|---|---|---|---|---|---|
| | | | | | | | | | | OH | Equiva- | ality | | Resistance, |
| Example | | % | Monomer Composition | | | | | | | Value (on | lent | (OH-eq/ | M_{w} | MEK double |
| No. | Resin | Solids | HEA | BA | STY | MMA | HPA | BMA | AA | solution) | Weight | Kg-resin) | (g · mol⁻¹) | rubs |
| 17 | — | 67 | | 19 | 20 | 0.5 | 40 | 18.5 | 2.0 | 111.5 | 503.1 | 3.0 | 8557 | >100 |
| 18 | — | 66.7 | 30 | 60 | 10 | | | | | 92.9 | 603.9 | 2.5 | 4076 | 93 |
| 19 | — | 67.87 | 35 | 25 | 35 | 5 | | | | 113.2 | 495.6 | 3.0 | 10088 | >100 |
| 20 | — | 69.18 | 35 | 40 | 25 | | | | | 106.9 | 524.8 | 2.8 | 9540 | >100 |
| 21 | HPH-7700 | 90 | | | | | | | | | | | | 5 |
| (comparative) | (polyester)¹ | | | | | | | | | | | | | |
| 22 | Polybutyl | 60 | | | | | | | | | | | | 2 |
| (comparative) | acrylate² | | | | | | | | | | | | | |

¹Polyester was a condensate of hexahydrophthalic anhydride and neopentyl glycol (42.5/57.5 weight ratio) having a hydroxyl value of 275-300 and number average molecular weight (Mₙ) of 300-400 g · mol⁻¹.
²Polybutyl acrylate in xylene solvent available from DuPont as RK-5345.
HEA = Hydroxyethyl acrylate,
BA = Butyl acrylate,
STY = Styrene,
MMA = Methyl methacrylate,
HPA = Hydroxypropyl acrylate,
BMA = Butyl methacrylate and
AA = Acrylic acid.

Example 10 was repeated but the coating composition contained no phosphotungstic acid catalyst. The resultant coating had 5 MEK double rubs.

### Examples 23-31

The following Examples show curing of various ester/hydroxyl functional acrylic polymers. The polymers were prepared by conventional solution polymerization techniques in methyl isobutyl ketone using a peroxide catalyst (LUPEROX 575). The polymers had a solids content of 40% by weight. Coating compositions were formulated with 1, 2 and 4% by weight phosphotungstic acid based on weight of resin solids. The coatings were drawn down with a #18 wire wound drawbar over steel substrates and cured for 10 minutes at 400° F. (204° C.). The films were tested for cure using MEK double rubs. The results are reported in Table IV below.

TABLE IV
Coatings Formulated with Ester/Hydroxyl Functional Acrylic Polymers

| | | | | | | | MEK |
|---|---|---|---|---|---|---|---|
| Example | Monomer Composition | | | | | | Double |
| No. | STY | HEA | BA | AA | % PTA | Mₙ (g · mol⁻¹) | Rubs |
| 23 | 40 | 30 | 30 | | 1 | 4930 | 65 |
| 24 | 40 | 30 | 30 | | 2 | 4930 | >100 |
| 25 | 40 | 30 | 30 | | 4 | 4930 | >100 |
| 26 | 30 | 30 | 30 | 10 | 1 | 12,233 | >100 |
| 27 | 30 | 30 | 30 | 10 | 2 | 12,233 | >100 |
| 28 | 30 | 30 | 30 | 10 | 4 | 12,233 | >100 |
| 29 | 70 | 30 | | | 1 | 5479 | >100 |
| 30 | 70 | 30 | | | 2 | 5479 | >100 |
| 31 | 70 | 30 | | | 4 | 5479 | >100 |

STY = Styrene,
HEA = Hydroxyethyl acrylate,
BA = Butyl acrylate,
AA = Acrylic acid, and
PTA = Phosphotungstic acid.

1. A container comprising a thermoset coating applied to at least a portion thereof, the coating derived from a composition comprising:
(a) one or more ingredients containing hydroxyester groups, said composition being essentially free of curing agents that have groups that are co-reactive with hydroxyl groups, and being substantially free of bisphenol A and derivatives of bisphenol A, and
(b) a transesterification catalyst.

2. The coated container of claim 1 in which (a) contains multiple ingredients comprising:
(i) a polymer containing beta-hydroxyester groups, and
(ii) a compound or polymer different from (i) containing hydroxyl groups.

3. The coated container of claim 2 in which (i) is an acrylic polymer.

4. The coated container of claim 2 in which (ii) is an acrylic polymer.

5. The coated container of claim 2 in which (ii) is a polyester polyol.

6. The coated container of claim 1 in which (a) contains a single ingredient.

7. The coated container of claim 6 in which (a) is an acrylic polymer.

8. The coated container of claim 7 in which the acrylic polymer also contains pendant lower alkyl ester groups.

9. The coated container of claim 8 in which the lower alkyl ester groups are derived from dimethyl itaconate.

10. The coated container of claim 1 in which (b) comprises phosphotungstic acid.

11. The coated container of claim 1 in which the composition is substantially free of aminoplast, phenolplast and isocyanate curing agents.

12. (canceled)

13. A method of coating a container comprising:
(a) applying to a surface of the container a thermosetting composition comprising:
(i) one or more ingredients containing beta-hydroxyester groups, the composition being essentially free of curing agents containing functional groups that are reactive with hydroxyl groups, and being substantially free of bisphenol A and derivatives of bisphenol A, and
(ii) a transesterification catalyst;
(b) heating the composition applied in step (a) to a temperature sufficient to cure the composition.

14. The method of claim 13 in which (i) is applied by spraying or curtain coating.

15. The method of claim 13 in which (b) is conducted at a temperature of 175 to 230° C.
